(19) United States
(12) Patent Application Publication
(10) Pub. No.: US 2011/0135007 A1
(43) Pub. Date: Jun. 9, 2011

(54) Entropy-Coded Lattice Vector Quantization

(76) Inventors: Adriana Vasilache, Tampere (FI); Marcel Cezar Vasilache, Tampere (FI)

(21) Appl. No.: 13/001,792

(22) PCT Filed: Jun. 30, 2008
(86) PCT No.: PCT/EP2008/058401

§ 371 Date: Feb. 16, 2011

(51) Int. Cl. H04N 7/28; G10L 19/00

(52) U.S. Cl. 375/240.22; 704/500; 375/E07.209; 704/E19.001

(57) ABSTRACT

An apparatus configured to: generate a first quantized signal by applying a lattice quantization to an encoded signal; determine at least one parameter of the first quantized signal; and encode the at least one parameter of the first quantized signal.

### FIELD OF THE INVENTION

The present invention relates to apparatus for coding, and in particular, but not exclusively for apparatus for quantization of speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are perceptually less important than the low frequencies. This in some audio codecs is reflected by a bit allocation where fewer bits are allocated to high frequency signals than low frequency signals.

Quantization of these encoded signals approximates the large number of discrete values generated by the audio codec to reduce the signal bandwidth required to store or transmit the coded signal.

Typical quantization approaches used in both audio and video coding is that of vector quantization (VQ) where several samples or coefficients are grouped together in vectors and each vector is then quantized or approximated with one entry of a codebook. The entry selected to quantize the input vector is typically the nearest neighbour in the codebook according to a distance criterion. As would be understood adding more entries with the codebook would increase the bit rate and the complexity but reduce the average distortion. The codebook entries are typically referred to as codevectors.

Construction of the codebook can be made by several ways, for example a training algorithm may be made to optimize the entries according to the source distribution.

In other known examples a structured codebook can be generated. One such structured codebook approach is the lattice vector quantization. In lattice vector quantization (lattice or algebraic VQ) the codebook is formed by selecting a subset of lattice points in a given lattice.

A lattice is a linear structure in N dimensions where all points or vectors can be obtained by integer combinations of N basis vectors. In other words all points can be obtained by a weighted sum of basis vectors with signed integer weights. A mathematical expression of any lattice point in a 2-dimensional lattice structure may for example be defined by:

$$y = {k}_{1} {v}_{1} + {k}_{2} {v}_{2} , or$$

$$y = [ {y}_{1} {y}_{2} ] = [ {k}_{1} {k}_{2} ] [ \begin{matrix}{v}_{1} \\ {v}_{2}\end{matrix} ] = [ {k}_{1} {k}_{2} ] [ \begin{matrix}{v}_{11} & {v}_{12} \\ {v}_{21} & {v}_{22}\end{matrix} ]$$

where the lattice point y is defined by a basis vectors v and integers k. The basis vectors may themselves be formed from the generators vᵢⱼ.

Typically the selected subset of lattice points rely on fixed rate or semi-variable rate coding (where the vector to be quantized is divided into sub-blocks for which the rate is variable but the overall bit rate for the global vector is fixed). An example of the semi-variable rate coding can be found in the IEEE paper “Low-complexity multi-rate lattice vector quantization with application to wideband TCX speech coding at 32 kbit/s” by Ragot et al. in Acoustics, Speech and Signal Processing, ICASSP '04 proceedings, Vol. 1 Pgs 501-504.

Furthermore variable rate encoding of the lattice codevectors has been attempted using grouping of codevectors on classes such as leader classes or shells for example as discussed in “indexing and entropy coding of lattice codevectors” by Vasilache et al. in Acoustics, Speech and Signal Processing, ICASSP '01 proceedings, Vol 4 Pgs 2605-2608.

In some approaches variable rate encoding has been achieved by directly applying entropy encoding techniques to the lattice codevector components as discussed in “GMM-Based Entropy-Constrained Vector Quantization” by Zhao et al. in Acoustics, Speech and Signal Processing, ICASSP '07, Vol 4 Pgs 1097-1100.

However there is a problem with regards to the implementation of such approaches. For example the leader classes or shell based entropy coding methods become difficult to implement as the number of classes increases—with the increase of the bit rate and for some of the truncation shapes. The directly applied entropy encoding on the lattice components although being less complex to implement produces a less efficient encoding.

There is therefore the problem associated with all of the prior approaches of practically attempting to consider each codevector individually even for high dimensional codebooks.

### SUMMARY OF THE INVENTION

This invention proceeds from the consideration that rather than entropy coding the resultant final index of the lattice codevector, the entropy coding can be applied on some intermediary values produced in the process of indexing to enable a simpler implementation for higher dimensionality and bit rates and further making the process less dependent on the source statistics.

Embodiments of the present invention aim to address or at least partially mitigate the above problem.

There is provided according to a first aspect of the present invention an apparatus configured to generate a first quantized signal by applying a lattice quantization to an encoded signal; determine at least one parameter of the first quantized signal; and encode the at least one parameter of the first quantized signal.

Thus embodiments of the invention may reduce the complexity of an encoding by directly encoding the parameter of the quantized signal rather than encoding a index derived from the parameters which may require significant processing to carry out.

The apparatus is preferably further configured to entropy encode the at least one parameter of the first quantized signal quantized signal.

The first quantized signal is preferably a vector comprising at least one component value.

The at least one parameter may comprise at least one of: the number of significant value components in the first quantized signal; the value of the maximum value components in the first quantized signal; the number of maximum value components within the significant value components; the position of the maximum value components in the first quantized signal; the value of the significant value components which are not maximum value components; the position of the significant value components which are not maximum value components; and the sign of the significant value components.

The at least one parameter may comprises at least one of: the number of significant value components in the first quantized signal; the value of the maximum value components in the first quantized signal; the position of the significant value components in the first quantized signal; the number of maximum value components out of the significant value components in the first quantized signal; the position of the maximum value components in the significant value components in the first quantized signal; the values of the significant value components which are not maximum value components; and the signs of the significant value components.

The significant value component is preferably at least one first quantized signal vector component with an absolute value greater than a first predefined threshold.

The first predefined threshold is preferably zero.

The maximum significant value component is preferably at least one first quantized signal vector component with the greatest absolute value.

The apparatus is preferably an encoder.

The apparatus is preferably at least one of: an audio encoder; a video encoder; and an image encoder.

According to a second aspect of the invention there is provided an apparatus configured to: decode a first part of an encoded signal to determine at least one parameter of a first quantized signal; and generate from the at least one parameter the first quantized signal.

The apparatus may be further configured to entropy decode the first part of the encoded signal to determine the at least one parameter of the first quantized signal.

The apparatus may be further configured to decode a second part of the encoded signal to determine a lattice configuration used to generate the first quantized signal.

The apparatus may be further configured to generate the first quantized signal further dependent on the lattice configuration used to generate the first quantized signal.

The at least one parameter of the first quantized signal may comprise at least one of: the number of significant value components in the first quantized signal; the value of the maximum value components in the first quantized signal; the number of maximum value components within the significant value components; the position of the maximum value components in the first quantized signal; the value of the significant value components which are not maximum value components; the position of the significant value components which are not maximum value components; and the sign of the significant value components:

The at least one parameter of the first quantized signal may comprise at least one of: the number of significant value components in the first quantized signal; the value of the maximum value components in the first quantized signal; the position of the significant value components in the first quantized signal; the number of maximum value components out of the significant value components in the first quantized signal; the position of the maximum value components in the significant value components in the first quantized signal; the values of the significant value components which are not maximum value components; and the signs of the significant value components

The first quantized signal may comprise at least one vector wherein each vector comprises at least one transform coefficient.

The apparatus may be a decoder.

The apparatus is preferably at least one of: an audio decoder; a video decoder; and an image decoder.

According to a third aspect of the present invention there is provided a method comprising: generating a first quantized signal by applying a lattice quantization to an encoded signal; determining at least one parameter of the first quantized signal; and encoding the at least one parameter of the first quantized signal.

The method may further comprise entropy encoding the at least one parameter of the first quantized signal quantized signal.

The first quantized signal is preferably a vector comprising at least one component value.

The at least one parameter may comprise at least one of: the number of significant value components in the first quantized signal; the value of the maximum value components in the first quantized signal; the number of maximum value components within the significant value components; the position of the maximum value components in the first quantized signal; the value of the significant value components which are not maximum value components; the position of the significant value components which are not maximum value components; and the sign of the significant value components.

The at least one parameter may comprise at least one of: the number of significant value components in the first quantized signal; the value of the maximum value components in the first quantized signal; the position of the significant value components in the first quantized signal; the number of maximum value components out of the significant value components in the first quantized signal; the position of the maximum value components in the significant value components in the first quantized signal; the values of the significant value components which are not maximum value components; and the signs of the significant value components.

The significant value component is preferably at least one first quantized signal vector component with an absolute value greater than a first predefined threshold.

The first predefined threshold is preferably zero.

The maximum significant value component is preferably at least one first quantized signal vector component with the greatest absolute value.

The method is preferably carried out in an encoder.

The method is preferably at least one of: an audio encoding; a video encoding; and an image encoding.

According to a fourth aspect of the invention there is provided a method comprising: decoding a first part of an encoded signal to determine at least one parameter of a first quantized signal; and generating from the at least one parameter the first quantized signal.

The method may further comprise entropy decoding the first part of the encoded signal to determine the at least one parameter of the first quantized signal.

The method may further comprise decoding a second part of the encoded signal to determine a lattice configuration used to generate the first quantized signal.

The method may further comprise generating the first quantized signal further dependent on the lattice configuration used to generate the first quantized signal.

The at least one parameter of the first quantized signal may comprise at least one of: the number of significant value components in the first quantized signal; the value of the maximum value components in the first quantized signal; the number of maximum value components within the significant value components; the position of the maximum value components in the first quantized signal; the value of the significant value components which are not maximum value components; the position of the significant value components which are not maximum value components; and the sign of the significant value components:

The at least one parameter of the first quantized signal may comprise at least one of: the number of significant value components in the first quantized signal; the value of the maximum value components in the first quantized signal; the position of the significant value components in the first quantized signal; the number of maximum value components out of the significant value components in the first quantized signal; the position of the maximum value components in the significant value components in the first quantized signal; the values of the significant value components which are not maximum value components; and the signs of the significant value components.

The first quantized signal may comprise at least one vector wherein each vector comprises at least one transform coefficient.

The method is preferably performed in a decoder.

The method is preferably at least one of: an audio decoding; a video decoding; and an image decoding.

An electronic device may comprise an apparatus as described above.

A chipset may comprise an apparatus as described above.

According to a fifth aspect of the invention there is provided a computer program product configured to perform a method comprising: generating a first quantized signal by applying a lattice quantization to an encoded signal; determining at least one parameter of the first quantized signal; and encoding the at least one parameter of the first quantized signal.

According to a sixth aspect of the invention there is provided a computer program product configured to perform a method comprising: decoding a first part of an encoded signal to determine at least one parameter of a first quantized signal; and generating from the at least one parameter the first quantized signal.

According to a seventh aspect of the invention there is provided an apparatus comprising: first processing means for generating a first quantized signal by applying a lattice quantization to an encoded signal; second processing means for determining at least one parameter of the first quantized signal; and encoding means for encoding the at least one parameter of the first quantized signal.

According to an eighth aspect of the invention there is provided an apparatus comprising: decoding means for decoding a first part of an encoded signal to determine at least one parameter of a first quantized signal; and processing means for generating from the at least one parameter the first quantized signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows schematically a quantization part of the encoder shown in FIG. 3;

FIG. 5 shows a flow diagram illustrating the operation of an embodiment of the audio encoder as shown in FIG. 3 according to the present invention;

FIG. 6 shows a graphical representation demonstrating the improvement of the signal to noise ratio gain accorded by embodiments of the invention; and

FIG. 7 shows schematically a decoder part of the audio codec system shown in FIG. 2;

FIG. 8 shows a flow diagram illustrating the operation of an embodiment of the audio decoder as shown in FIG. 7 according to the present invention.

### DESCRIPTION OF PREFERRED EMBODIMENTS OF THE INVENTION

The following describes in more detail possible mechanisms for the quantization of encoded signals. Although the below examples describe an audio encoded signal being quantized according to embodiments of the invention it would be understood that the invention may be embodied to provide improved quantization of other encoded signals. These may be but are not limited to encoded video, image, audio, or speech or combinations of these encoded signals.

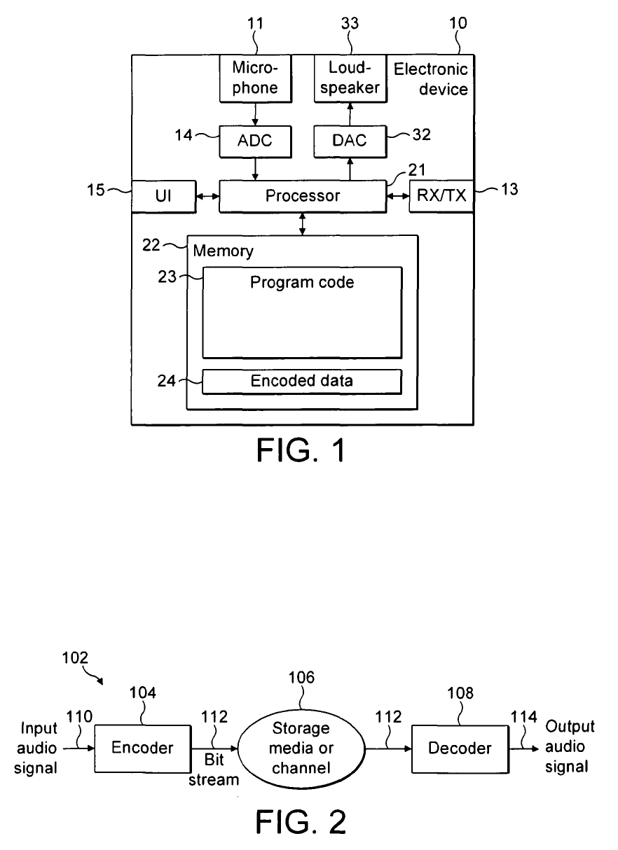

Reference is first made to FIG. 1 which shows a schematic block diagram of an exemplary electronic device 10 or apparatus, which may incorporate a quantization codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a combined audio signal and code to extract and encode side information pertaining to the spatial information of the multiple channels. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

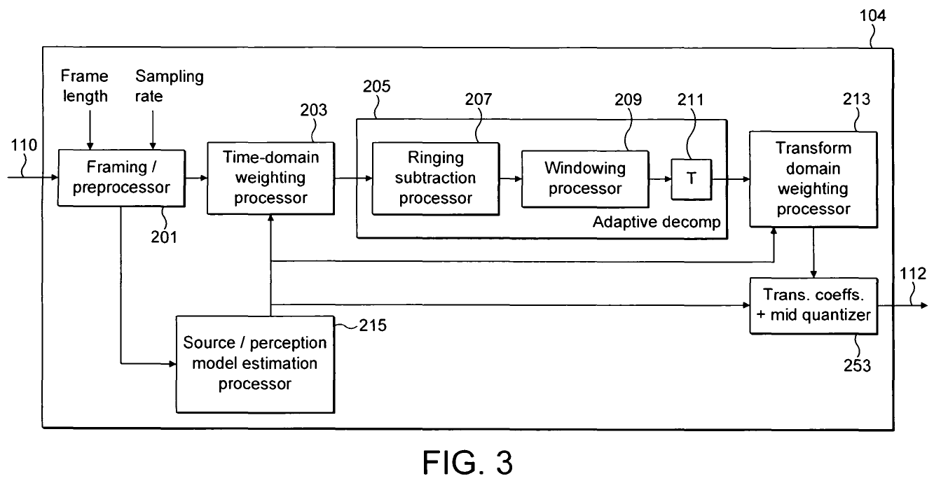

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

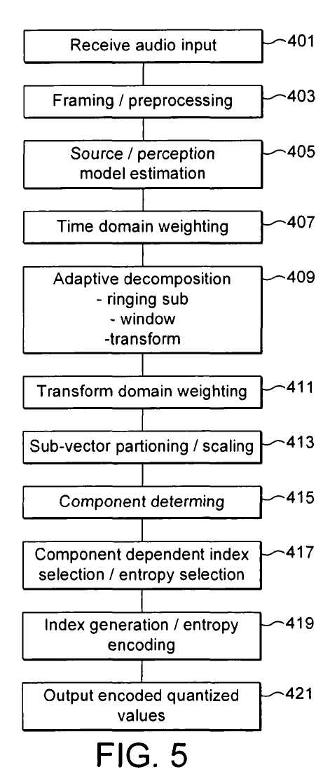

It would be appreciated that the schematic structures described in FIGS. 2, 3, 4, and the method steps in FIG. 5 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

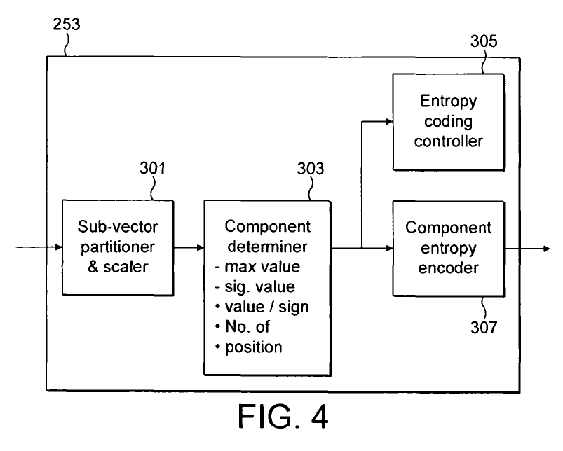

FIGS. 3 and 4 depicts schematically an encoder 104 and in particular a quantizer 253 according to an exemplary embodiment of the invention. The operation of an encoder incorporating an embodiment of the invention is shown as a flow diagram in FIG. 5.

The encoder 104 in step 301 receives the original audio signal. In a first embodiment of the invention the audio signal is a digitally sampled signal. In other embodiments of the present invention the audio input may be an analogue audio signal, for example from a microphone 11, which is analogue to digitally (A/D) converted by an ADC 14. In further embodiments of the invention the audio input is converted from a pulse code modulation digital signal to amplitude modulation digital signal.

The Framing Pre-processor 201 frames and in some embodiments of the invention pre-processes the audio signal. The Framing/Pre-processor receives information concerning the frame length variable and the sampling rate and segments the received samples into frames of arbitrary length dependent on the frame length variable. Furthermore the Framing/Pre-processor 201 may additionally segment each frame into an arbitrary number of sub-frames. The segmentation of the frames and sub-frames depends on the configuration of the coder, and in some embodiments of the invention, frames and sub-frames can be overlapped.

The Framing Pre-processor 201 may in some embodiments of the invention perform a high-pass filtering of the audio signal. In some embodiments for example a high-pass filter with a cut-off frequency of 67 Hz may be applied to the audio signal to attempt to remove the direct current component of the signal to be encoded.

The Framing and Pre-processing of the audio signal is shown in FIG. 5 by step 403.

The output of the Framing Pre-processor 201 is connected to the Source Modeller 215 and the Time Domain Weighting Processor 203.

The Source Modeller 215, also known as the Source/perception model estimation and quantizer receives the framed and pre-processed audio signal and applies a signal model to determine a series of p-order linear prediction coding (LPC) coefficients and a prediction gain every 20 ms. Furthermore the Source Modeller 215 generates an open-loop pitch period estimate every 10 ms.

The signal model comprising of the LPC model and pitch model based on the open-loop pitch period estimate is used as basis for the derivation of a van de Par perceptual model.

The estimation of components for the source/perception model is shown in FIG. 5 by step 405.

The Time Domain Weighting Processor 203 receives the framed and pre-processed frames and sub-frames and performs a time domain weighting function on the signal dependent on the estimated model parameters passed to the Time. Domain Weighting Processor 203 from the Source Modeller 215. The Time Domain Weighting Processor 203 uses a perceptual filter obtained from the perceptual model generated within the Source Modeller 215 to remove the irrelevancy from the signal to be encoded. In other words from the source modelling the framed audio signal has removed any time domain components which would be masked according to the perceptual signal.

The Time Domain weighting of the audio signal is shown in FIG. 5 by step 407.

The Time Domain Weighting processor 203 output is connected to the Adaptive Decomposator 205. The Adaptive Decomposator performs a series of actions to process the Time Domain. Weighted signals.

The first action is performed by the Ringing Subtraction Processor 207 which receives the output of the Time Domain Weighting processor 203 input to the Adaptive Decomposator 205. The Ringing Subtraction Processor attempts to remove the intra-block dependencies within the signal. The output of the Ringing Subtraction Processor 207 is then passed to the Windowing Processor 209.

The Windowing Processor 209 then applies a time domain windowing or weighting to the input signals. The windowing function applied is dependent on the type of transform applied in the Transformer 211. In some embodiments of the invention the Windowing Processor 209 applies a window stitching mechanism.

The Transformer 211 receives the windowed signal and applies a transform to the audio signal. The Transformer 211 in a first embodiment of the invention is a Karhunen-Loeve Transform (KLT). In other embodiments of the invention other transforms may be used which although may change some of the data flow of the embodiment compared with the above mentioned embodiment should not affect the architecture as the components of the architecture are designed to be generic. Other types of transform are for example the Modulated Lapped Transform (MLT). The Transformer 211 outputs a series of transform coefficients.

The Adaptive Decomposation of the signal can be shown in FIG. 5 by the step 409.

The transformed signal transform coefficients are then further processed in the Transform Domain Weighting Processor 213 which may in some embodiments of the invention be a normalisation of the signal. In some embodiments of the invention the Transform Domain Weighting Processor 213 may perform a further weighting of the transformed signals in order to remove any transform dependent irrelevance. For example where the transformer operates to generate frequency coefficients the Transform Domain Weighting Processor 213 may dependent on the perceptual model generate a perceptual model to mask one frequency coefficient due to a dominating nearby frequency band signal.

The transform domain weighting process is shown in FIG. 5 by step 411.

The output of the Transform. Domain Weighting Processor 213 is then passed to the Quantizer 253.

The Quantizer 253 is shown in further detail with respect to FIG. 4.

The Quantizer 253 comprises a sub-vector partitioner and scaler 301 which receives the transformed coefficients and outputs partitioned and scaled sub-vectors comprising groups of the transformed coefficients.

The sub-vector partitioner 301 performs a partitioning of the transformed coefficients according to predetermined transform coefficient bands to produce sub-vectors with a given dimensionality smaller than the total vector size. For example where the Transformer generates a frequency domain coefficient the bands may be defined according to frequency bands.

The process of partitioning the sub-vectors is shown in FIG. 5 in step 413.

The component determiner 303 receives the partitioned sub-vectors and gathers the information contained in the sub-vector which is used within the lattice quantization process.

As described previously, lattice quantization attempts to describe a sub-vector in terms of a point or position within a n dimensional space defined by a lattice, for example the Zₙ lattice.

In the below mentioned example, the Zₙ lattice corresponds to a rectangular truncated lattice which is used to generate the vector quantization for each sub-vector of components. However in further embodiments of the invention, different lattices may be used.

A brief description of lattice quantization will now follow in order to help to understand the information being gathered by the component's determiner 303.

A Zₙ lattice contains all integer coordinate points of the n dimensional space. The dimension of the respective Zₙ lattice may be equal to the number of coefficients in the sub-vector. If a Zₙ lattice is used, the lattice quantization corresponds to rounding the scaled coefficients to the nearest integer to obtain quantized coefficients.

In a truncated lattice; the number of points of the lattice is limited. A finite truncation of the lattice forms a “codebook” and a respective point can be represented by a “codevector” listing a value for each dimension.

A rectangular truncated lattice, which we describe in this example as Zₙ, within which the code vector is included, allows for a simple indexing algorithm.

The regular truncation uses the maximum absolute norm of a vector.

y=(y₁, y₂, . . . , yₙ)εRⁿ

This is defined as:

N(y)=max_{i=1:n}|yᵢ|

The rectangular truncation of the lattice Λ is defined as:

$${Λ}_{K} = \{ ( {x}_{1} , {x}_{2} , … , {x}_{n} ) ∈ Λ \vert {max}_{i} \vert {x}_{i} \vert \leq K \}$$

In the above n is the lattice dimension, x₁ to xₙ are the code vector components or transformed coefficients and K is the maximum norm of the truncated lattice. Thus, the maximum absolute value any component x₁ to xₙ of any code vector may take is equal to K.

A generalisation of the above formula is the truncation having a different maximum norm along different dimensions.

$${Λ}_{\{ {K}_{i} \}} = \{ ( {x}_{1} , {x}_{2} , … , {x}_{n} ) ∈ Λ \vert {max}_{i} \vert {x}_{i} \vert \leq {K}_{i} \}$$

In the following example the Zₙ lattice has the same maximum norm along all of the dimensions, however in some embodiments of the invention, different norms may be employed.

The exterior shell defined by the truncation is formed by the points.

$${\overline{Λ}}_{K} = \{ ( {x}_{1} , {x}_{2} , … , {x}_{n} ) ∈ Λ \vert {max}_{i} \vert {x}_{i} \vert = K \}$$

It is these points which we are interested in indexing.

A point from the outer rectangular shell of a Zₙ lattice of maximum norm K is thus a vector of integer components having at least one component of an absolute value equal to K, while all other components have absolute values less or equal to K.

If the norm K of the truncated regular lattice is always selected to be equal to the maximum value of the components of a respective code vector, a code vector could be considered to be a point from the shell of the truncated lattice. The norm for a rectangular truncated lattice may further be selected separately for each sub-band to correspond to the norm. That is, the maximum absolute value of a respective code vector representing the quantized transformed coefficients of the sub-band.

Each code vector resulting in the quantization can be represented by a respective index. That is, instead of encoding each vector component seperately, a single index may be generated and provided as an encoded audio signal for a respective vector, as will be described in more detail further below. The indexation component performs its indexing for each subband.

In addition the information generated by the component determiner 303 may be encoded by the entropy encoded part of the index generator at entropy encoder 307 as described below also.

The component determiner 303 therefore receives the partitioned and scaled n-dimensional integer code vector (x₁, x₂, . . . , xₙ) having a maximum absolute norm equal to K (as produced by scalling the sub-vector within the sub-vector partitioner and scalier 301) and representing a point from the outter rectangular shell of a truncated Zₙ lattice. The component determiner 303 proceeds to determine the following entities.
1A. The number of the significant (non zero) components in the vector.
1B. The value of the maximum component(s) (in absolute value).
1C. The number of maximum valued components (in absolute value) within the significant ones.
1D. The position within the entire vector of the maximum valued components.
1E. The values of the significant non-maximum components.
1F. The positions of the significant non-maximum values within the remaining null and non-maximum values.
1G. The signs of the significant components.

In a further embodiment of the invention, the component determiner 303 may calculate the same information but using different representations. Thus, for example, in a further embodiment, the components determined may be:
2A. The number of significant components in the vector.
2B. The value of the maximum components (in absolute value).
2C. The position of the significant components within the entire vector.
2D. The number of maximum values components out of the significant ones.
2E. The position of the maximum valued components within the significant ones.
2F. The values of the non-maximum significant components.
2G. The signs of the significant components.

The information components determined by the component determiner 303 may be interpreted as a classification of the sub-vectors into various sets. In other words the classification means that the sub-vectors are divided in groups of sub-vectors having the same value for the number of significant components, furthermore within these groups a classification based on the value of the maximum value of the components can be made and so on.

The index generated as will be described later corresponding to all or part of the set or sub-set types are entropy coded and an entropy code can be obtained for the initial lattice vector.

The information calculated by the component determiner 303 may be passed to the index and entropy coding controller 305 and also the index generator and entropy encoder 307.

For example, using the KLT transform for wideband signals and a sub-frame length of 5 ms 80 spectral components may be generated for each sub-frame. Using the D₄ lattice we can in this example divide the 80 spectral components into groups of 10 sub-vectors—each sub-vector being the quantized integer value of 4 coefficient values fitted to the lattice. In some embodiments of the invention the sub-vectors may be grouped, for example each group may have 10 sub-vectors which use common arithmetic encoders. In other embodiments of the invention the choice of the number of sub-vectors may differ in order to produce advantageous results according to the audio signal statistical properties.

An example of a four-dimensional sub-vector may be the integer values of (2-3 0-1). Using this sub-vector the component determiner 303 is able to determine that the maximum norm value is equal to 3 (i.e. 1B=3). Furthermore the component determiner 303 may determine that it has three significant components (1A=3) as only one of the coefficients produces a zero value. The component determiner 303 may determine there is one maximum valued component (1C=1) with an index value 1 (1D=01), in other words the maximum valued component is located at the second index position, the first index position having a value of 0 and the third and fourth index positions having the values of 2 and 3. The component determiner 303 may furthermore generate an index of 1 for the position of the non-maximum valued components (1F=1). In this embodiment example there are 3 non-maximum components and the position of the non-zero one within these can be xx0, x0x, 0xx, therefore the index is 1. The signs of the maximum and the significant values may also be generated by calculating the values of a binary word where ‘0’ represents a positive signed component of the vector and ‘1’ represents a negative signed component of the vector. Thus in this example the binary word would be 011 from the ‘+’, ‘−’, ‘−’ values of the non-zero components and the decimal value would be 3 (1G=3).

It would be understood that the component determiner may be configured to generate the component values in an order which allows adaptive determination.

For example in determining the first series of components 1x, the component determiner 303 may determine that there are no significant components in the sub-vector (1A=0) and thus immediately halt further determination for the sub-vector and generate null component values for the remaining components. Similarly if there is only one significant value (1A=1) then the value of the number of maximum values components is also 1 (1C=1) and the values of the significant non-maximum value components 1E and 1F are null as there are no non-significant maximum values.

In some embodiments of the invention the component determining further keeps statistical records of the components and can pass these statistical values to the index and entropy coding controller 305.

The process of determining the component values for the sub-vectors is shown in FIG. 5 in step 415.

The entropy coding controller 305 receives the component values determined by the component determiner 303. The index and entropy coding controller 305 configures the index generator and entropy encoder 307 dependent on the values of the information from the component determiner 303.

Thus, for example, the entropy coding controller 305 may be configured so that if the number of significant elements other than the maximum value coefficient is zero (the information being received from the component determiner 303) then the entropy coding controller switches off the relevant sections or parts of the component entropy encoder 307, which generates an entropy code based on the significant component values.

As there is a clear dependency between some of the information generated by the component determiner 303 then these information component values are to be taken into account when encoding.

As the example uses a 4 component vector there is at least one and up to four significant values and therefore there are four possible symbols to be indexed and entropy encoded. Similarly there are any number of one to four maximum valued components to be entropy encoded.

In a further example of the entropy encoding being in context of the determined component values if we consider that there are 2 significant values out of a possible 4 then there are 6 possible ways of picking 2 positions from 4 and so the encoder can predefine the 6 possible symbols and simply select one rather than generate a symbol in real time. Similarly further examples would define a entropy encoder with predefined symbols for 3 significant values from 4 and 1 significant value from 4. This in embodiments of the invention may be extended for the non-maximum positions.

By using the component values the entropy coding controller can determine the exact number of maximum value and significant value components needed to be indexed and entropy encoded.

In some embodiments of the invention the entropy coding controller 305 may operate using a differential controller scheme, in other words a control signal is passed from the entropy coding controller 305 to the component entropy encoder 307 only when a different encoding parameter is required to be passed. Thus where the encoding is the same across sub-vectors or groups of sub-vectors no additional signals are passed from the entropy coding controller 305 to the component entropy encoder 307.

The component entropy encoder 307 generates the entropy encoding dependent on the setting up of the encoder by the entropy encoding controller 305 and using the sub-vector component values generated by the component determiner 303. The entropy coding of the component values can be Huffman coding, Shannon coding, arithmetic coding, or any other encoding method that may attempt to assign smaller codeword length to the more frequent values of the component values.

The difference between these embodiments and the prior art may be seen in that where the prior art generates a codevector index from the sub-vector index value approximation on the lattice the present invention embodiments effectively split the lattice codevector indices into several units (or components which are integers as well and define the vector) which may be entropy encoded directly without need to generate indices and which do not significantly degrade the performance of the system provided that the decoder also has knowledge of these values.

The index may be generated from a combination of symbols generated dependent on each of the components determined by the component determiner. Thus the symbols for the information 1A to 1G or 2A to 2G may be derived directly from their values and from the enumerative indices attached to them.

For example it is possible to generate the symbols directly from the values of 1A the number of significant components, 1B the value of the maximum component, and 1C the number of maximum valued components directly and enumeratively generate indices associated with 1A, 1B, and 1C for the values of 1C the number of maximum valued components (in absolute value) within the significant ones, 1D the position within the entire vector of the maximum valued components, 1E values of the significant non-maximum components, 1F the positions of the significant non-maximum values within the remaining null and non-maximum values, and 1G the signs of the significant components.

In some embodiments of the invention the determination of indices for 1D and 1F may be generated from the enumeration of Binominal coefficient.

Further in some embodiments of the invention, the index of the sign is obtained by using the determined value number—i.e. generating a binary word where assigning a value of ‘1’ to the negative significant components and the value ‘0’ to the positive ones and calculating the decimal value of the obtained binary word.

The index for the values of the non-maximum components may be calculated in some embodiments using the base representation indexing.

Examples of index generation, both direct and enumerative, procedures can be found within US-2008/0097757 which describes the generation of index components.

The creation of the index for the position of the maximum valued components within the significant ones may be implemented using slight modifications where a lattice other than Zₙ is used but where the lattice is still derived from Zₙ. For example where the lattice Dₙ is used, which is a set of all of the Zₙ points having the sum of the components as an even number, the index resulting from the Zₙ base representation indexing may be divided by 2.

In embodiments where the lattice may not be easily derived from Zₙ, a supplementary modification by the inverse of the generator matrix of the lattice would transform the data to a Zₙ type space (even though possibly being tilted).

The entropy encoding is shown in FIG. 5 by step 419.

The encoder 104 then outputs the encoded quantized audio signal as shown in FIG. 5 by step 421.

The implementation of the index and entropy coding controller and index generator and entropy controller controlled dependent on the component determined values by the component determiner 303 are that in comparison with the previous implementations, there is a smaller number of symbols and entropy coding required. This makes a much more practical implementation when compared to the previous implementations. The smaller number of symbols for entropy encoding is particularly advantageous for allowing entropy encoding of lattice code vectors. The use of rectangular truncation increases the flexibility with respect to the statistics of the data, however at the same time, it may produce many unused lattice code vectors even in relatively low bitrate implementations which increase the number of symbols required to be entropy encoded

Furthermore by controlling the index and entropy encoding dependent on the component values determined, the changes in the statistical properties of the data can be easily followed and therefore the independence of the equiprobability surfaces of data may be determined.

The independence of the equiprobability surfaces improves the performance of the invention over the prior implementations as the entropy encoding methods used, such as the canonical Huffman coding deal with a large number of symbols and are not easily made adaptive and produce better results when they presume the same probability to all the code vectors from one shell thus making it necessary to have a close correspondence between the shape of the truncation and the probability of the data. In other words the canonical Huffman coding adapted to lattice codevectors assumes that the codevectors belonging from one shell for instance have the same probability. This is true if the source itself has the same symmetry. If we assume a Gaussian source, the source data would have the same probability along some hyperspheres. The lattice truncation chosen in this example may be spherical and the corresponding shells forming the lattice truncation would generate spherical shells. Thus in embodiments of the invention there may be a need to define beforehand a type of truncation, so if a Gaussian source is assumed with spherical truncation and shells, but the source is actually Laplacian, there would be a mismatch between the real probability of the codevectors and the one assumed in the entropy coding.

Furthermore, the component determiner can generate the information 1A to 1G (or 2A to 2G) which correspond to relevant characteristics of the data and thus model the quantization easier to the statistics of the component values. Furthermore the index and entropy coder may exploit correlations between the information or component values to control the index and entropy encoder. For example if there are vectors with 1 significant value only there may be a higher probability that neighbouring vectors (in other words adjacent locations in the current frame or the same location in the previous frame) has only one significant value also (similarly for maximum values). Thus in embodiments of the invention a differential or predictive coding may be employed to exploit this correlation.

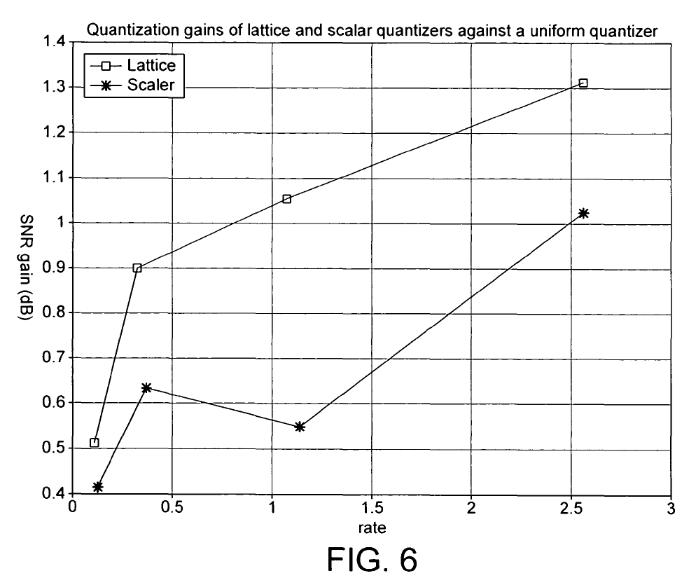

Furthermore the index generator and entropy encoder 307 under the control of the index and entropy coding controller 305 has the advantage of a lower memory requirement in comparison with indexing on leaders for which each leader vector should be kept in memory. Thus for non-rectangular truncations the leader vectors may be stored. The leader vectors may in some embodiments of the invention be generated on the fly but this would increase the complexity of the codec operation. In embodiments using rectangular truncation only the maximum absolute value for each dimension may be stored. In comparison with methods which entropy encode only the individual components of the lattice code vectors, the embodiments shown produce fewer symbols and the better performance as indicated by FIG. 6.

FIG. 6, for example, presents the comparison between a known implementation and an embodiment of the present invention in the context of spectral coefficients encoding within a speech and audio encoder for an overall bit rate from 7 kb/s to 46 kb/s. The comparison is expressed as in terms of signal to noise ratio.

The lattice considered for quantization is the D4 lattice discussed above. In the example, a modulated lapped transform (MLT) is used directly to the signal on a sub-frame basis.

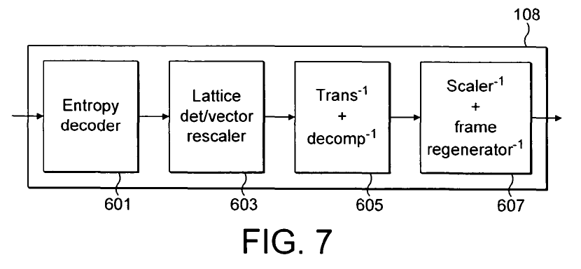

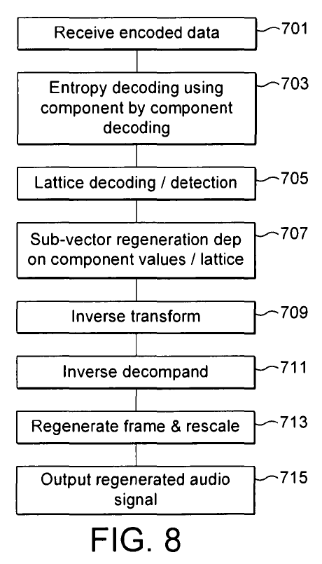

With respect to FIG. 7 a schematic view of an embodiment of a decoder 108 is shown. Furthermore the operation of the decoder will be further explained with the assistance of FIG. 8.

The decoder as implemented in embodiments of the invention receives the entropy encoded signal in the entropy decoder 601. The entropy decoder performs an entropy decoding of the entropy encoded signal to retrieve the component values, any entropy encoded lattice definitions, and any other entropy encoded side information required to decode the audio signal.

The reception of the signal at the decoder is shown in FIG. 8 by step 701.

The entropy decoder 601 specifically decodes the entropy encoded component values in such a manner that the dependencies in the components may be exploited in order to assist in the decoding. Therefore in a manner similar to the component determiner 303 and the component entropy encoder 307 the decoder processes the decoding of the components component by component and where the decoding of a component affects the possible decoding of the next or further components the decoder is able to skip or automatically generate the further component generated values.

Thus for example where the entropy decoder determines that the decoded value of the number of significant values is equal to zero the decoder halts decoding of this sub-vector and outputs a series of null values to represent that there are no values for the other components.

Similarly if the entropy decoder 601 determined that there the decoded value of the number of significant values is equal to one then the decoder generates null values for the component values associated with the absolute values and positions of the significant non-maximum values (1E and 1F respectively).

In some component encoding scheme embodiments the dependence chain xA, xB need not be continuous, meaning that xA and xB may be independent as well, depending on the type of the components which has been encoded.

In some embodiments of the invention all the probabilities associated with the entropy encoding and decoding are initialized with some off-line trained values and then adapted on-line. The decoding may therefore be understood to be the inverse operation of any encoding operation in other words reading first the code for xA (the code associated with the first component), which would enable the decoder to know what the possible decoded values for xB may be and what may be the codes for each possible value xB, so we will know how to interpret the code for xB.

The entropy decoder may in some embodiments further receive an entropy encoded code defining the lattice used in the quantization of the sub-vector and furthermore generate an index value associated with the lattice used.

The operation of the entropy decoding 601 is shown in FIG. 8 by step 703.

Both the lattice value and the component values may then be passed to the lattice detector/sub-vector regenerator 603.

The lattice detector/vector regenerator 603 determines the lattice arrangement used in the quantization process within the encoder.

The detection of the lattice arrangement is shown in FIG. 8 by step 705.

Furthermore the lattice detector/vector regenerator 603 using the component values and the determined lattice arrangement is configured to regenerate the sub-vector (with the errors generated by the quantization process).

The regeneration of the sub-vector operation is shown in FIG. 8 by step 707.

The sub-vector information is then passed to the inverse transformer and inverse decompander 605.

The inverse transformer and inverse decompander 605 first performs an inverse transform to that performed within the encoder.

The operation of the inverse transformation is shown in FIG. 8 by step 709.

The inverse transformer and inverse decompander 605 furthermore may perform a inverse decompanding operation to reverse the remaining decompanding operation as carried out within the encoder 104.

The inverse decompanding operation is shown in FIG. 8 by step 711.

The output of the inverse transformer and inverse decompander 605 is input to a inverse scaler and frame regenerator 607. The inverse scaler and frame regenerator 607 carries out the reverse processes to the scaling carried out according to the audio model employed and furthermore regenerates the audio signal from the frame structure used in the encoder 104.

The rescaling and regenerating of the audio signal is shown in FIG. 8 by step 713.

Finally the regenerated audio signal is output as shown in FIG. 8 by step 715.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device or apparatus 10, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

Furthermore embodiments of the invention may operate within a codec within an electronic device or apparatus as part of a video codec configured to perform lattice quantization on the video, frame or picture image.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-44. (canceled)

45. An apparatus configured to:
generate a first quantized signal by applying a lattice quantization to an encoded signal;
determine at least one parameter of the first quantized signal; and
encode the at least one parameter of the first quantized signal.

46. The apparatus as claimed in claim 45, is further configured to entropy encode the at least one parameter of the first quantized signal quantized signal.

47. The apparatus as claimed in claim 45, wherein the first quantized signal is a vector comprising at least one component value.

48. The apparatus as claimed in claim 47, wherein at least one parameter comprises at least one of:
the number of significant value components in the first quantized signal;
the value of the maximum value components in the first quantized signal;
the number of maximum value components within the significant value components;
the position of the maximum value components in the first quantized signal;
the value of the significant value components which are not maximum value components;
the position of the significant value components which are not maximum value components; and
the sign of the significant value components.

49. The apparatus as claimed in claim 47, wherein the at least one parameter comprises at least one of:
the number of significant value components in the first quantized signal;
the value of the maximum value components in the first quantized signal;
the position of the significant value components in the first quantized signal;
the number of maximum value components out of the significant value components in the first quantized signal;
the position of the maximum value components in the significant value components in the first quantized signal;
the values of the significant value components which are not maximum value components; and
the signs of the significant value components.

50. The apparatus as claimed in claim 48, wherein the significant value component is at least one first quantized signal vector component with an absolute value greater than a first predefined threshold.

51. The apparatus as claimed in claim 50, wherein the first predefined threshold is zero.

52. The apparatus as claimed in claim 48, wherein the maximum significant value component is at least one first quantized signal vector component with the greatest absolute value.

53. The apparatus as claimed in claim 45, wherein the apparatus is an encoder.

54. The apparatus as claimed in claim 45, wherein the apparatus is at least one of:
an audio encoder;
a video encoder; and
an image encoder.

55. An apparatus configured to:
decode a first part of an encoded signal to determine at least one parameter of a first quantized signal; and
generate from the at least one parameter the first quantized signal.

56. The apparatus as claimed in claim 55, further configured to entropy decode the first part of the encoded signal to determine the at least one parameter of the first quantized signal.

57. The apparatus as claimed in claim 55, further configured to decode a second part of the encoded signal to determine a lattice configuration used to generate the first quantized signal.

58. The apparatus as claimed in claim 57, further configured to generate the first quantized signal further dependent on the lattice configuration used to generate the first quantized signal.

59. The apparatus as claimed in claim 55, wherein the at least one parameter of the first quantized signal comprises at least one of:
the number of significant value components in the first quantized signal;
the value of the maximum value components in the first quantized signal;
the number of maximum value components within the significant value components;
the position of the maximum value components in the first quantized signal;
the value of the significant value components which are not maximum value components;
the position of the significant value components which are not maximum value components; and
the sign of the significant value components.

60. The apparatus as claimed in claim 55, wherein the at least one parameter of the first quantized signal comprises at least one of:
the number of significant value components in the first quantized signal;
the value of the maximum value components in the first quantized signal;
the position of the significant value components in the first quantized signal;
the number of maximum value components out of the significant value components in the first quantized signal;
the position of the maximum value components in the significant value components in the first quantized signal;
the values of the significant value components which are not maximum value components; and
the signs of the significant value components.

61. The apparatus as claimed in claim 55, wherein the first quantized signal comprises at least one vector wherein each vector comprises at least one transform coefficient.

62. The apparatus as claimed in claim 55, wherein the apparatus is a decoder.

63. The apparatus as claimed in claim 55, wherein the apparatus is at least one of:
an audio decoder;
a video decoder; and
an image decoder.

64. A method comprising:
generating a first quantized signal by applying a lattice quantization to encoded signal;
determining at least one parameter of the first quantized signal; and
encoding the at least one parameter of the first quantized signal.

65. The method as claimed in claim 64, further comprising entropy encoding the at least one parameter of the first quantized signal quantized signal.

66. A method comprising:
decoding a first part of an encoded signal to determine at least one parameter of a first quantized signal; and
generating from the at least one parameter the first quantized signal.

67. The method as claimed in claim 66, further comprising entropy decoding the first part of the encoded signal to determine the at least one parameter of the first quantized signal.

68. An electronic device comprising apparatus as claimed in claim 45.

69. A chipset comprising apparatus as claimed in claim 45.
